(19) United States
(12) Patent Application Publication
(10) Pub. No.: US 2011/0075058 A1
(43) Pub. Date: Mar. 31, 2011

(54) REPLACEABLE RESILIENT HOUSING COVER FOR CONSUMER ELECTRONICS DEVICE

(75) Inventors: MAHYAR NEJAT, La Jolla, CA (US); Brian Kim, San Diego, CA (US)

(73) Assignee: SONY CORPORATION and SONY ELECTRONICS INC.

(21) Appl. No.: 12/568,404

(22) Filed: Sep. 28, 2009

(51) Int. Cl. H04N 5/64

(52) U.S. Cl. 348/836; 348/E05.128

(57) ABSTRACT

Deformable resilient covers are provided for home network CE devices such as a TV and its remote control (RC) so that, for example, and end user can color coordinate the covers and/or replace one cover with another of a different color for variety.

### FIELD OF THE INVENTION

The present invention relates generally to monitoring wireless link quality in network-enabled TVs and more specifically for providing indications thereof to a user.

### BACKGROUND OF THE INVENTION

Consumer electronics devices such as televisions may be sold in different colors to suit a consumer's taste. Specifically, in the case of TVs for instance, the hard plastic bezel that frames the display may be sold in one of various colors from which the consumer can choose.

### SUMMARY OF THE INVENTION

As understood herein, it is desirable to provide a means by which a consumer can change the color of portions of a housing of a consumer electronics (CE) device after purchase should the user grow tired of the color in which the CE device was vended. It may also be desirable to provide a means to establish a tactilely different feel for the housing of a CE device after purchase, and further to color-coordinate CE devices with their respective RCs as desired by the end user.

Accordingly, a system for a display held in a hard non-deformable housing including a bezel includes a flexible housing cover made of flexible material and shaped like the bezel. The cover has a front piece and rear piece that is opposed to and parallel with the front piece. The front and rear pieces have identical sizes and shapes and are connected by left and right side edge pieces. At least the front piece defines an open rectilinear window through which the display is visible when the cover covers the bezel. The front and/or rear pieces are deformable by an end user to slide the cover onto the bezel and then releasable to assume a configuration in which the bezel is completely covered by the cover with the bezel sandwiched between the front and rear pieces and with four hard edges of the bezel advantageously covered by the cover for a pleasant and safe cushioning effect.

In some embodiments the side edge pieces are identically sized and shaped to each other and are parallel to each other but do not have the same dimensions as the front and rear pieces. More specifically, all four pieces can have the same maximum length in a vertical dimension defined by the display, but the front and rear pieces extend inwardly further in a width dimension defined by the display than do the side pieces so that a space is established between the front and rear pieces for receiving the bezel therein.

The front and rear pieces may be connected at their top and bottom edges by top and bottom pieces respectively that are identically sized and shaped to each other and are parallel to each other but which do not have the same dimensions as the front and rear pieces. More specifically, the front, rear, top, and bottom pieces can have the same maximum width in a width dimension defined by the display, but the front and rear pieces can extend inwardly further in a vertical dimension defined by the display than do the top and bottom pieces.

In examples described further below, edges of the bezel abut the side edge pieces with the front piece covering substantially the entire front surface of the bezel and being flush therewith but not covering any portion of a front surface of the display so that the display is completely visible in a window formed by the cover. If desired, a raised tongue can be formed on either the cover or bezel a groove formed in the other of the bezel or cover to receive the tongue therein. No adhesive need ever used to hold the cover onto the bezel.

In another aspect, a deformable resilient cover includes a body, a cavity formed in the body and configured to closely receive a home network consumer electronics (CE) device remote control (RC) therein, and an open window in the body through which the RC is advanceable into the cavity. When the RC is in the cover, a top surface of the RC that bears control keys is exposed.

In another aspect, a kit of parts includes a deformable resilient device cover configured to bound an outer periphery of a home network consumer electronics (CE) device. The kit also includes a deformable resilient remote control (RC) cover configured to bound a periphery of a RC associated with the CE device. The covers have the same color so that a user can engage the covers with the CE device and RC, respectively to color code the RC with the CE device.

In another aspect, a system for holding a display framed by a hard non-deformable housing having an edge bezel and backed by a rear panel includes a resilient housing cover made of flexible material. The cover, which may be made from a unitary piece of resilient deformable material, includes a rear continuous sheet completely covering the entire rear panel when the cover is engaged with the housing. The rear sheet defines a rectilinear periphery and flexible material completely fills the periphery. Respective raised edge pieces are disposed along the entire length of each respective side of the periphery and are oriented generally orthogonally to the flexible material filling the periphery. The raised edge pieces terminate in respective top edges that are closely juxtaposed with the display viewing surface when the cover is engaged with the housing.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example home network in accordance with present principles;

FIG. 2 is a perspective view of an example home network CE device housing cover in an exploded relationship with an example home network CE device, in this case, a flat panel TV;

FIG. 3 is a cross-section as seen along the line 3-3 in FIG. 2;

FIG. 4 is a perspective view of another example home network CE device housing cover in an exploded relationship with an example home network CE device, in this case, a TV RC;

FIG. 5 is a perspective view of another example home network CE device housing cover in an exploded relationship with an example home network CE device, in this case, a flat panel TV; and

FIG. 6 is a close-up view of a portion of the cover on an alternate display as would be seen in the box 6-6 in FIG. 5, showing the display periphery in phantom.

### DETAILED DESCRIPTION OF THE PREFERRED EMBODIMENT

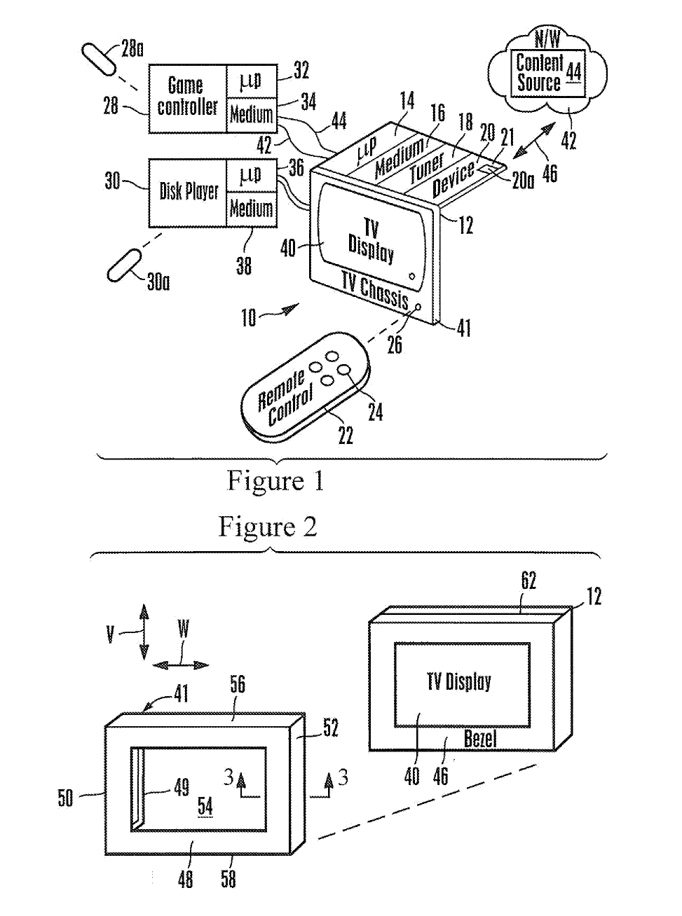

Referring initially to FIG. 1, a TV system 10 includes a TV housing 12 holding a TV processor 14 accessing a computer-readable storage medium 16 such as disk-based or solid state storage that can be non-volatile memory (NVM). The medium 16 may bear a software-implemented network manager module executable by the TV processor 14 alone or acting in concert with the below-described network interface processor to undertake logic herein. Furthermore, the medium 16 may bear software executable by the TV processor 14 to enable reception and display of Internet content on the TV.

The housing 12 may also hold a TV tuner 18 communicating TV signals to the TV processor 14. There need be only a single analog/digital TV tuner 18 provided in the TV system 10, it being understood that the single analog/digital TV tuner 18 may be physically implemented by one and only one combined digital/analog tuner or by a single digital tuner or by one and only one digital tuner in combination with one and only one analog tuner. In other embodiments only a single analog tuner and no digital tuners may be provided. The tuner 18 may be provided in the housing 12 or in a set-top box, and the tuner 18 may receive TV signals from a satellite e, cable head end, terrestrial broadcast antenna, etc.

A network interface device 20 such as but not limited to an Internet enabled wireless modem may be provided to send Internet signals to the TV processor 14. The device 20 typically includes a processor 20a and a lower level wireless driver 21 that is programmed to gather link quality information including one or more of wireless signal strength, data rate, packet loss, and streaming delay. The interface device 20 may be supported by the TV housing 12 or it may be external to the housing but communicating with the TV processor 14. Without limitation the network interface 20 may be a 802.11a/b/g/n transceiver, a 60 GHz transceiver, or other transceiver that can stream high quality multimedia content.

As shown, the TV system 10 also includes a portable hand-holdable TV remote control (RC) 22. The RC 22, among other things, can have cursor control keys 24 for sending wireless signals to a receiver 26 on the housing 12. The signals detected by the receiver 26 are sent to the TV processor 14.

In some embodiments the TV system 10 may receive video from a game console 28 such as but not limited to a console in the Sony Playstation® family and/or from a digital disk player 30 such as a Blu Ray® disk player. The console 28 typically includes a game processor 32 accessing a game storage medium 34 storing audio and/or video data and likewise the disk player 30 typically includes a disk processor 36 accessing a disk storage medium 38 storing audio and/or video data. The game console can have a game remote control 28a and the disk player can be associated with a wireless disk player remote control 30a.

Content from the TV tuner 18 and, when provided, from the game console 28/disk player 30 may be presented under control of the TV processor 14 on a TV display 40 such as but not limited to a plasma display or flat panel matrix-type display, either standard definition (SD) and/or high definition (HD). A resilient frame cover 41 removably encases the hard plastic bezel that frames the display 40 in accordance with principles described below.

In one example embodiment the components shown in FIG. 1 communicate multimedia data to each other over high definition multimedia interface (HDMI) links 42, and the components also communicate control data over consumer electronics control (CEC) links 44 that typically accompany HDMI links. In the example non-limiting architecture shown in FIG. 1 the TV 10 is the central node of the network but it is to be understood that all components may be linked together directly or only some components may be linked together directly, with communication to other components potentially passing through intervening components. In any case, additional content sources such as but not limited universal serial bus (USB) mass storage, personal video recorders (PVR), digital cameras, set-top boxes, removable memory media, etc. may be used in conjunction with the TV system 10.

FIG. 1 shows that the TV can wirelessly receive multimedia data such as audio, video, or still picture data from a network 42 that includes one or more content sources 44. The network 42 may be the Internet and the sources 44 may be established by servers that stream content over wireless links 46 to the TV for reception thereof by the wireless interface 20.

The TV (e.g., TV display 40), RC 22, game console 28, and disk player 30 are examples of home network CE devices whose housings may be partially or completely encased within a flexible housing cover in accordance with present principles. For purposes of this application, “home network CE device” can include the above-described components but explicitly excludes telephones and keyboards. For illustration, the TV display 40 will be used as an example.

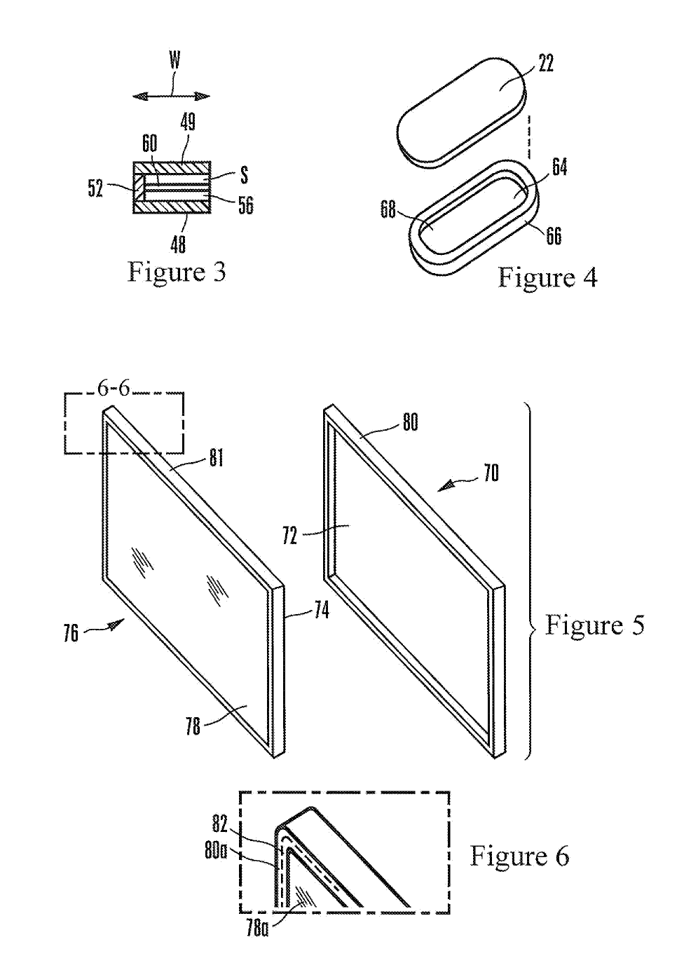

Cross-referencing FIGS. 2 and 3, a flexible housing cover 41 that may be made of a unitary piece of resilient deformable material such as silicone or rubber is shown shaped like the housing of the home network CE device it is intended to cover, in this example, a hard non-deformable non-resilient bezel 46 that frames the TV display 40 and that defines part of the housing 12 of the TV shown in FIG. 1. The cover 41 has a front piece 48 and rear piece 49 that is opposed to and parallel with the front piece 48. In the example shown, the front and rear pieces 48, 49 have identical sizes and shapes and are connected by left and right side edge pieces 50, 52. All four pieces 48-52 are parallelepiped-shaped, with the front and rear pieces 48, 49 defining an open rectilinear window 54 through which the display 40 is visible when the cover 41 covers the bezel 46. Preferably, the window 54 has the same planar dimensions as the display 40 as shown. In some embodiments, however, the rear piece 49 may be larger or smaller than shown.

The side edge pieces 50, 52 are identically sized and shaped to each other and are parallel to each other but as shown in FIG. 3 do not have the same dimensions as the front and rear pieces 48, 49. Specifically, while FIG. 2 shows that all four pieces 48-52 have the same maximum length in the vertical dimension “V” in FIG. 2, as perhaps best shown in FIG. 3 the front and rear pieces 48, 49 extend inwardly further in the width dimension “W” than do the side pieces 50, 52, so that a space “S” is established between the front and rear pieces 48, 49.

Similarly, the front and rear pieces 48, 49 are connected at their top and bottom edges by top and bottom pieces 56, 58 that are identically sized and shaped to each other and are parallel to each other but which do not have the same dimensions as the front and rear pieces 48, 49. Specifically, while FIG. 2 shows that all four pieces 48, 49, 56, 58 have the same maximum width in the width dimension “W” in FIG. 2, as perhaps best shown in FIG. 3 the front and rear pieces 48, 49 extend inwardly further in the vertical dimension “V” than do the top and bottom pieces 56, 58.

It may now be appreciated that the edges of the bezel abut the side edge pieces 50, 52 and the top and bottom pieces 56, 58 with the front piece 48 covering substantially the entire front surface of the bezel 46 and being flush therewith when the cover 41 is engaged with the bezel 46, but not covering any portion of the front surface of the display 40 so that the display 40 is completely visible in the window 54. The housing 12 framing the TV, including the bezel 46, resides in the space “S” shown in FIG. 3.

Accordingly, because the cover 41 is flexible and more preferably is deformable and resilient, the front and/or rear pieces 48, 49 can be deformed by the end user and the cover 41 slid onto the bezel 46, then released to assume a configuration in which the bezel 46 is completely covered by the cover with the bezel 46 sandwiched between the front and rear pieces 48, 49 and with the four hard edges of the bezel 46 advantageously covered by the top, bottom, and side pieces 56, 58, 50, 52 for a pleasant and safe cushioning effect.

If desired, to further engage the cover 41 with the bezel 46, a tongue 60 may be formed in, e.g., the top piece 56 as best shown in FIG. 3 to be closely received in a groove 62 (FIG. 2) formed in the top edge of the bezel 46. The tongue may be formed in other edge pieces of the cover 41 and more than one edge piece may be formed with a tongue. Alternatively, one or more edge pieces may be formed with a respective groove and a respective raised tongue provided on the bezel 46 to protrude into the channel. However, it is preferred that no glue or adhesive is ever used to hold the cover 41 onto the bezel 46; in this way, a user can simply and easily engage and disengage the cover 41 with the bezel 46 so that, for example, one day the user may place a blue cover 41 on the TV and the next a red cover and so on, changing the appearance of the TV.

Terms of direction in the example above are relative to how a viewer looks at the cover 41 when it is engaged with the TV as intended and shown in FIG. 1.

FIG. 4 shows that the RC 22 shown in Figure can be closely received in a complementarily-shaped cavity 64 of a deformable resilient possibly Silicone RC cover 66. The RC cover 66 is an open window 68 through which the RC 22 is advanced into the cavity 64 and which exposes the top surface of the RC 22 that bears the control keys discussed above. The outer contour of the cover 66 may be identical to the contour of the RC 22 as shown if desired so that the RC 22 with removable cover 66 retains the same shape as the RC 22 without the cover.

If desired, the covers 41, 66 may be provided together in a kit and may have coordinated colors so that a user may purchase the kit and use the covers to cover both the RC 22 and TV. The colors of the covers may be identical to each other so that the user in effect can color code the RC 22 to match the TV by means of the covers 41, 66. It is to be understood that kits with covers for other components having remote controls may likewise be provided so that a user can color coordinate all the RCs in the home network 10 with their respective components. For example, red covers may be provided for the game controller 28 and game RC 28a; green covers may be provided for the disk player 30 and disk RC 30a; and blue covers 41, 66 may be provided for the TV and TV RC 22.

FIG. 5 shows that a flexible, preferably resilient and deformable cover 70 may be made of a unitary piece of material and may include a flat rear continuous sheet 72 completely covering the entire rear panel 74 of a TV 76 having a display 78 when the cover 70 is engaged with the housing of the TV. As shown, the rear sheet 72 defines a rectilinear periphery, and flexible material completely fills the periphery.

Respective raised edge pieces 80 are disposed along the entire length of each respective side of the periphery as shown. The edge pieces 80, which may be parallelepiped-shaped, are raised relative to the rear sheet 72 and so are oriented generally orthogonally to the flexible material filling the periphery of the rear sheet 72 as shown. In the embodiment shown in FIG. 5 the periphery of the display 78 is framed by a rectilinear edge bezel 81 such that the bezel 81 essentially forms the edges of a housing, with the edge pieces 80 lying against respective outer sides of the bezel.

The raised edge pieces 80 terminate in respective top edges 82 that are closely juxtaposed with the display surface of the display 78. In one embodiment the top edges 80 can be substantially co-planar with the display viewing surface when the cover is engaged with the housing, i.e., the top edges 82 do not overlap the periphery of the display. In an alternate embodiment shown in FIG. 6 top edge pieces 80a slightly bend over the plane of the viewing surface of a display 78a when the cover is engaged with the housing, i.e., the top edge pieces 80a bend over a periphery 82 of the display by a slight amount, e.g., a few millimeters.

The cover 70 results in a low cost solution since one unitary cover piece can be used for both a rear panel cover and a bezel cover. Accordingly, the cover 70 covers the back of any printed wiring boards PWBs that are mounted to the rear panel 74 of the TV. Furthermore, manufacturing cost and time are reduced because no screws are necessary to mount the single piece cover 70 to the TV. And as described above, the end user has the opportunity to change the cosmetic look of the TV by replacing a cover 70 of one color or design pattern with another similar cover of a different color or design. The weight of the assembly is also lowered due to the material used to make the assembly a more environmental friendly product.

While the particular REPLACEABLE RESILIENT HOUSING COVER FOR CONSUMER ELECTRONICS DEVICE is herein shown and described in detail, it is to be understood that the subject matter which is encompassed by the present invention is limited only by the claims.

What is claimed is:

1. System for holding a display framed by a hard non-deformable housing having a front bezel, comprising:
a resilient housing cover made of flexible material and shaped like the bezel, the cover having:
a front piece and rear piece that is opposed to and parallel with the front piece, the front and rear pieces having identical sizes and shapes and being connected by left and right side edge pieces,
at least the front piece defining an open rectilinear window through which the display is visible when the cover covers the bezel, the front and/or rear pieces being deformable by an end user to slide the cover onto the bezel and then releasable to assume a configuration in which the bezel is completely covered by the cover with the bezel sandwiched between the front and rear pieces and with four hard edges of the bezel advantageously covered by the cover for a pleasant and safe cushioning effect.

2. The system of claim 1, wherein the side edge pieces are identically sized and shaped to each other and are parallel to each other but do not have the same dimensions as the front and rear pieces.

3. The system of claim 2, wherein all four pieces have the same maximum length in a vertical dimension defined by the display, the front and rear pieces extending inwardly further in a width dimension defined by the display than do the side pieces so that a space is established between the front and rear pieces for receiving the bezel therein.

4. The system of claim 1, wherein the front and rear pieces are connected at their top and bottom edges by top and bottom pieces respectively that are identically sized and shaped to each other and are parallel to each other but which do not have the same dimensions as the front and rear pieces.

5. The system of claim 4, wherein the front, rear, top, and bottom pieces have the same maximum width in a width dimension defined by the display, the front and rear pieces extending inwardly further in a vertical dimension defined by the display than do the top and bottom pieces.

6. The system of claim 1, wherein edges of the bezel abut the side edge pieces with the front piece covering substantially the entire front surface of the bezel and being flush therewith but not covering any portion of a front surface of the display so that the display is completely visible in a window formed by the cover.

7. The system of claim 1, comprising at least one raised tongue on the cover or bezel and at least one groove in the other of the bezel or cover to receive the tongue therein.

8. The system of claim 1, wherein no adhesive is ever used to hold the cover onto the bezel.

9. System for holding a display framed by a hard non-deformable housing having an edge bezel and backed by a rear panel, the display defining a viewing surface, the system comprising:
a resilient housing cover made of flexible material, the cover having:
a rear continuous sheet completely covering the entire rear panel when the cover is engaged with the housing, the rear sheet defining a rectilinear periphery and flexible material completely filling the periphery;
respective raised edge pieces along the entire length of each respective side of the periphery and oriented generally orthogonally to the flexible material filling the periphery, the raised edge pieces terminating in respective top edges, the top edges being juxtaposed with the display viewing surface when the cover is engaged with the housing.

10. The system of claim 9, wherein the top edges are substantially co-planar with the viewing surface when the cover is engaged with the housing.

11. The system of claim 9, wherein the top edge pieces slightly bend over a plane defined by the viewing surface when the cover is engaged with the housing.

12. A kit of parts comprising:
a deformable resilient device cover configured to bound an outer periphery of a home network consumer electronics (CE) device;
a deformable resilient remote control (RC) cover configured to bound a periphery of a RC associated with the CE device, the covers having the same color so that a user can engage the covers with the CE device and RC, respectively to color code the RC with the CE device.

13. The kit of parts of claim 12, wherein the kit is a first kit, the color is a first color, the CE device is a first CE device, and the RC is a first RC, and the first kit is vended with a second kit having a second device cover configured to engage a second home network CE device and a second RC configured to engage a second RC associated with the second CE device, the second covers having a second color.

14. The kit of claim 12, wherein the CE device is a TV and the device cover includes:
a front piece and rear piece that is opposed to and parallel with the front piece, the front and rear pieces having identical sizes and shapes and being connected by left and right side edge pieces, at least the front piece defining an open rectilinear window through which a display of the TV is visible when the cover covers a bezel of the TV, the front and/or rear pieces being deformable by an end user to slide the cover onto the bezel and then releasable to assume a configuration in which the bezel is completely covered by the cover with the bezel sandwiched between the front and rear pieces and with four hard edges of the bezel advantageously covered by the cover for a pleasant and safe cushioning effect.

15. The kit of claim 14, wherein the side edge pieces are identically sized and shaped to each other and are parallel to each other but do not have the same dimensions as the front and rear pieces, wherein all four pieces have the same maximum length in a vertical dimension defined by the display, the front and rear pieces extending inwardly further in a width dimension defined by the display than do the side pieces so that a space is established between the front and rear pieces for receiving the bezel therein.

16. The kit of claim 14, wherein the front and rear pieces are connected at their top and bottom edges by top and bottom pieces respectively that are identically sized and shaped to each other and are parallel to each other but which do not have the same dimensions as the front and rear pieces, wherein the front, rear, top, and bottom pieces have the same maximum width in a width dimension defined by the display, the front and rear pieces extending inwardly further in a vertical dimension defined by the display than do the top and bottom pieces.

17. The kit of claim 14, wherein edges of the bezel abut the side edge pieces with the front piece covering substantially the entire front surface of the bezel and being flush therewith but not covering any portion of a front surface of the display so that the display is completely visible in a window formed by the cover.

18. The kit of claim 12, wherein the CE device is a TV device cover includes:
a rear continuous sheet completely covering a rear panel of the TV when the cover is engaged with the TV, the rear sheet defining a rectilinear periphery and flexible material completely filling the periphery; and
respective raised edge pieces along the entire length of each respective side of the periphery and oriented generally orthogonally to the flexible material filling the periphery, the raised edge pieces terminating in respective top edges, the top edges being juxtaposed with a display viewing surface of the TV when the cover is engaged with the TV.

19. The kit of claim 14, wherein the RC cover comprises:
a body;
a cavity formed in the body and configured to closely receive the RC therein,
the cover also being formed with an open window through which the RC is advanceable into the cavity such that a top surface of the RC that bears control keys is exposed when the RC is engaged with the cover.

20. The kit of claim 19, wherein an outer contour of the RC cover is identical to a contour of the RC so that the RC with removable RC cover retains the same shape as the RC without the cover.
